(19) United States
(12) Patent Application Publication
(10) Pub. No.: US 2005/0063563 A1
(43) Pub. Date: Mar. 24, 2005

(54) System and method for geolocation using imaging techniques

(76) Inventor: Samir S. Soliman, San Diego, CA (US)

Correspondence Address: Qualcomm Incorporated;Patents Department, 5775 Morehouse Drive, San Diego, CA, 92121-1714, US

(21) Appl. No.: 10/669,601

(22) Filed: Sep. 23, 2003

(51) Int. Cl. G06K 9/00

(52) U.S. Cl. 382/104; 382/106; 382/107

(57) ABSTRACT

An image capturing device of a wireless device is used to aid in location determination of the wireless device using imaging techniques. A scene is selected, an image of the scene is formed, and the image is then processed to determine location information based on the image. The location information is then displayed on tie wireless device or sent to a requesting entity. The scene may include a familiar landmark, a street sign or a coded sign with location information. Additionally, the scene may include an optical source transmitting an optical signal with location information.

### BACKGROUND

1. Field

The field of the present invention relates generally to determining the location of a device. More specifically, the invention relates to methods and apparatus for providing an estimate of the location of the device based on imaging techniques.

2. Background

The desire to determine accurately the location of wireless devices is being driven in part by regulatory mandates. The Federal Communications Commission (FCC) mandated support for wireless enhanced 911 (E-911) service with planned phased implementations. The E-911 rules seek to improve the effectiveness and reliability of 911 service by providing 911 dispatchers with additional information on wireless 911 calls.

The deployment of E-911 requires the development of new technologies and upgrades to local 911 Public Safety Answering Points (PSAPs), as well as coordination among public safety agencies, wireless carriers, technology vendors, equipment manufacturers, and local wireline carriers. Many techniques are being considered for providing location determination of wireless devices. A common method of locating a device is to determine the amount of time it takes for signals transmitted by known sources to reach the receiver of the device to be located.

One such source of transmitted signals is known as the Global Positioning Satellite (GPS) system. Signals from at least four GPS satellites are needed to extract location information. This technique's effectiveness is dependent on the geometry of GPS satellites available at any one time and the power received from them. For example, GPS signals may not effectively penetrate a building structure, and hence, will not be acquired by the GPS receiver.

Another technique of determining location of a device involves measuring the time difference of arrival signals from different wireless base stations, for example, cell sites. Triangulation requires signals from several base stations. Thus, this technique is dependent on the geometry and availability of a sufficient number of base stations.

Accordingly, it would be desirable to provide methods and apparatus for determining device location determination that do not depend on the availability of GPS satellites or cell sites or on the intensity of received signal levels. The methods and apparatus disclosed herein tend to satisfy this need.

### SUMMARY

The present invention provides for location determination using imaging techniques.

According to one aspect, a method includes acquiring an image of a scene, preparing the acquired image for transmission, transmitting the image to a processing center configured to process the prepared image to obtain the location information of the wireless device, receiving from the processing center the location information and displaying the location information.

In another aspect, a method includes acquiring an image of the scene, and processing the acquired image to obtain the location information of the wireless device.

In another aspect, a wireless device includes an image capturing device configured to acquire an image of a scene, a processor configured to prepare the acquired image for transmission, a transmitter configured to transmit the prepared image to a processing center, a receiver configured to receive location information derived from the prepared image, and a display configured to display the received location information.

In another aspect, a wireless device for determining location information comprises an image capturing device configured to acquire an image of a scene, a processor configured to process the acquired image to obtain the location information of the wireless device, and a display configured to display the location information.

In yet another embodiment, the wireless device includes a panic button for initiating the image capture process.

Other and further objects and advantages of the present invention will be further understood and appreciated by those skilled in the art by reference to the following specification, claims, and drawings.

### BRIEF DESCRIPTION OF THE FIGURES

FIG. 1 illustrates a system for location determination using image data.

FIG. 2 is a block diagram of the wireless device.

FIG. 3 is a flow diagram illustrating a method for determining the location of the wireless device.

### DETAILED DESCRIPTION

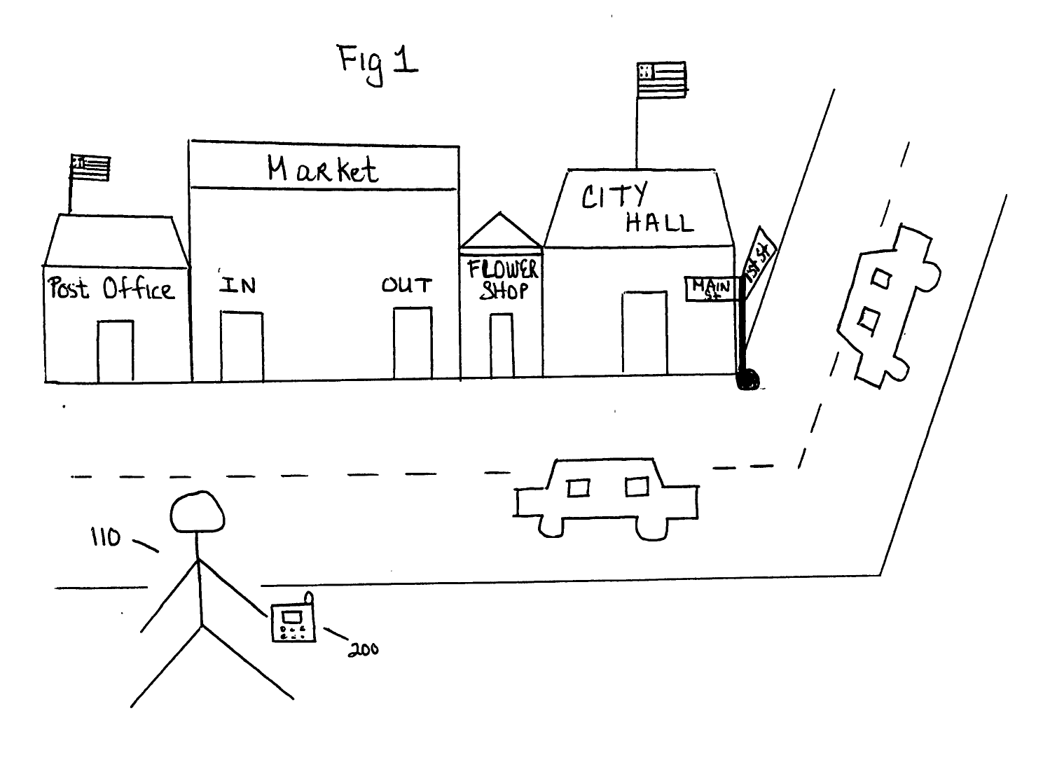

FIG. 1 illustrates a system for location determination using imaging techniques. A user 110 is at an undetermined location. The user 110 holds a wireless device 200 which is equipped with an image capturing device.

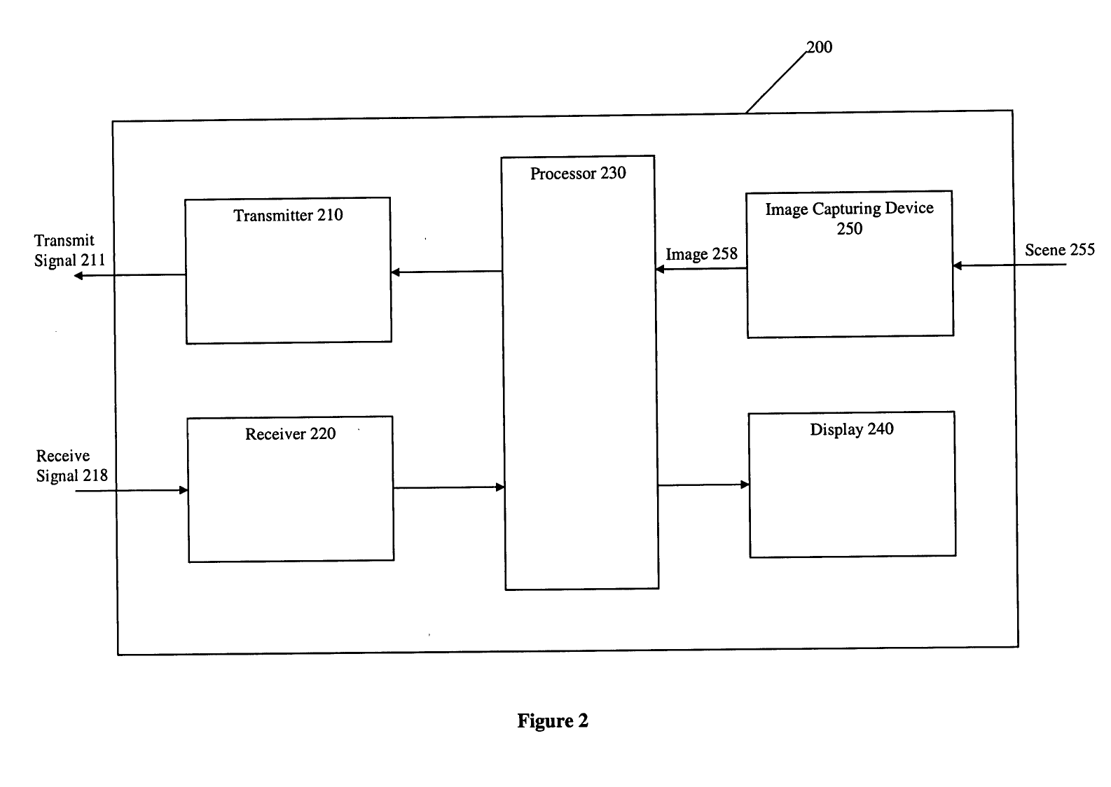

FIG. 2 is a block diagram of the wireless device 200. An image capturing device 250 may be a still camera that generates a snapshot or a video camera that generates a time-continuous picture or the like. The image capturing device 250 may generate either an analog or digital output. Additionally, the image capturing device 250 may have an adjustable, rotating and/or interchangeable reading head to allow three degrees of rotational freedom to permit better angular positioning towards a designated scene 255. The wireless device 200 also includes a transmitter 210 for transmitting a signal 211, a receiver 220 for receiving a signal 218, a processor 230 for processing an image 258 of the scene, and a display 240 for displaying information, including location coordinates. The transmitter 210 and the receiver 220 may be implemented as a single component. An antenna (not shown) may be a separate component or may be part of the transmitter 210 and/or receiver 220.

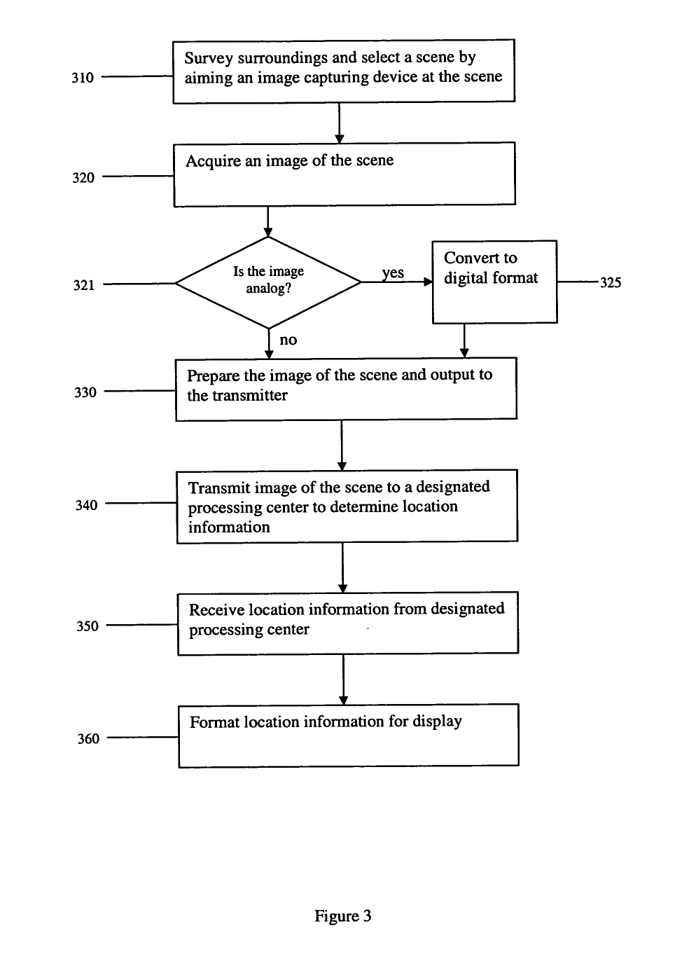

FIG. 3 is a flow diagram illustrating a method for determining the user's location of the wireless device. In step 310, user 110 surveys his surroundings and selects a scene 255 by aiming the image capturing device 250 at the scene that user 110 feels will provide the information about the user's location.

In step 320, the image capturing device 250 acquires an image 258 of the scene 255 and provides the image to processor 230. Processor 230 may determine if the image 258 is analog in step 321. If the image 258 is analog, the processor 230 may convert the image 258 to a digital form in step 325. Optionally, the image capturing device may convert the image to digital form prior to the output of the image capturing device 250 in step 325.

The image 258 is prepared by processor 230 for transmission using conventional algorithms, for example, image or video compression, framing, error control, addressing, etc., known to one skilled in the art, and then output to the transmitter 210 in step 330. In step 340, transmitter 210 transmits the prepared image 258 as transmit signal 211 to a designated image processing center (not shown) where the location determination is performed on the received image using location databases and appropriate image processing and recognition techniques known to one skilled in the art such as, but not limited to, computer vision, image correlation, pattern recognition, image classification, image recognition processing, etc.

Once the received image has been analyzed and location information has been extracted, the processing center can transmit the location information to an entity requesting such information, such as wireless device 200.

Once the location of the wireless device is determined, the location information can be formatted for display and sent by the designated image processing center as signal 218. The receiver 220 can receive the received signal 218 in step 350. In step 360, processor 230 can format the received signal to show location information on display 240. The location of the wireless device is then known to the user 110.

Location information may appear as an address, as a geographical designator (i.e., “you are at the eastern entrance of the Balboa Park Performance Art Building”), as latitude and longitude coordinates, as atlas directory page/grid information or in any other form known to one skilled in the art.

In another embodiment, the processor 230 of the wireless device 200 may include location databases and processing/recognition algorithms to analyze and extract location information from the image 258, instead of transmitting the image 258 to an image processing center for location determination. In one embodiment, the receiver 220 receives aiding information such as, but not limited to, a location database from a remote data center (not shown).

In one embodiment, the user 110 may choose a scene 255 that appears to be a landmark of the surroundings. For example, if the user 110 is in an unfamiliar town, a chosen scene could be the city hall building, a uniquely shaped building or a series of buildings which through its relative position to one another may provide information of its location. Natural scenery, such as a rock formation, could also be used.

In another embodiment, an intersection sign of two street names may provide location information such as the country, the state, the county, or the city. The street names can be translated to latitude and longitude coordinates by the processing center 290. This may be particularly useful if the user is in an unfamiliar foreign country, in the New England States where state borders are relatively close to each other, or in Europe where some country borders are also relatively close to each other. In yet another embodiment, special signs can be coded with location information. In this case, the user 110 can choose a specially coded sign as the scene 255 to determine his location and have the location information presented as a street address, latitude/longitude coordinates, geographical descriptor, etc.

In one embodiment, the user 110 may not be able to relate verbally information of his location to emergency personnel. Using the image 258 that is sent by the user's wireless device 200, the emergency personnel can determine whether the user 110 is indoors or outdoors, whether the user 110 is in an urban setting or a rural setting, or whether the user's surrounding conditions pose an immediate danger to the user 110. Additionally, if the location information is readily available on display 240, the user 110 can transmit the location information to the emergency personnel.

In another embodiment, indoor rooms, hallways, corridors, storage areas, etc. of large buildings can be coded with location information (i.e., standardized geographical grids) for quick identification. User 110 can transmit the coded information of his indoor location to determine his exact position in a building. This is especially useful when multiple buildings are connected and it is difficult to discern the building boundaries when the user 110 is moving indoors.

In one embodiment, the scene 255 includes an optical source (not shown) transmitting an optical signal. Image capturing device 250 can record the optical signal to form the image 258. Processor 230 can process image 258 for location determination (such as, but not limited to, street address, longitude and latitude coordinates, geographical designator, etc.) and shown on display 240. In an alternate embodiment, transmitter 210 transmits image 258 to the image processing center for location determination and then the location information is transmitted back to the receiver 220 to be presented on display 240.

In yet another embodiment, the wireless device includes a panic button, an image capturing device with adjustable/rotating head for acquiring an image of a scene, a processor for preparing the captured image for transmission, and a transmitter for transmitting the prepared image to a designated processing center. The processing center can process the image into the location information. The location information with the captured images may be displayed at the processing center or relayed to a requesting entity.

The capability of transmitting image data of scenery with location information of that scenery has a variety of applications such as monitoring of traffic conditions, weather, public safety, security access, etc.

While the present invention has been described in terms of the preferred embodiments, other variations which are within the scope of the invention as defined in the claims will be apparent to those skilled in the art.

1. A method of determining location information of a wireless device, the method comprising:
acquiring an image of a scene;
preparing the acquired image for transmission;
transmitting the prepared image to a processing center configured to process the prepared image to obtain the location information of the wireless device;
receiving from the processing center the location information; and
displaying the location information.

2. The method of claim 1, wherein preparing the acquired image using at least one algorithm selected from the group consisting of image compression, video compression, framing, error control, and addressing.

3. A method of determining location information of a wireless device, the method comprising:
acquiring an image of a scene; and
processing the acquired image to obtain the location information of the wireless device.

4. The method of claim 3, wherein processing the acquired image to obtain the location information of the wireless device using at least one algorithm selected from the group consisting of computer vision, image correlation, pattern recognition, image classification, and image recognition.

5. The method of claim 3 further comprising displaying the location information.

6. The method of claim 3 further comprising receiving aiding information from a remote data center.

7. The method of claim 6, wherein the aiding information includes a location database.

8. A wireless device comprising:
an image capturing device configured to acquire an image of a scene;
a processor configured to prepare the acquired image for transmission;
a transmitter configured to transmit the prepared image to a processing center;
a receiver configured to receive location information derived from the prepared image; and
a display configured to display the received location information.

9. The wireless device comprising of claim 8, wherein the processor prepares the acquired image for transmission using at least one algorithm selected from the group consisting of image compression, video compression, framing, error control, and addressing.

10. A wireless device for determining location information comprising:
an image capturing device configured to acquire an image of a scene;
a processor configured to process the acquired image to obtain the location information of the wireless device; and
a display configured to display the location information.

11. The wireless device of claim 10 wherein the processor processes the acquired image using at least one algorithm selected from the group consisting of image compression, video compression, framing, error control, and addressing.

12. The wireless device of claim 10 further comprising:
a transmitter configured to transmit a request for aiding information to a remote data center; and
a receiver configured to receive the aiding information;
wherein the processor process the acquired image using the aiding information.

13. The wireless device of claim 12, wherein the aiding information includes a location database.

14. The wireless device of claim 12, wherein the transmitter is further configured to transmit the location information to a requesting entity.

15. A wireless device for determining location information comprising:
means for acquiring an image of the scene;
means for preparing the acquired image for transmission;
means for transmitting the prepared image to a processing center for processing configured to process the prepared image to obtain the location information of the wireless device;
means for receiving from the processing center the location information; and
means for displaying the location information.

16. The wireless device of claim 15, wherein means for preparing the acquired image for transmission utilizes at least one algorithm selected from the group consisting of image compression, video compression, framing, error control, and addressing.

17. A wireless device for determining location information, comprising:
means for acquiring an image of a scene; and
means for processing the acquired image to obtain the location information of the wireless device.

18. The wireless device of claim 17, wherein means for processing the acquired image to obtain the location information of the wireless device utilizes at least one algorithm selected from the group consisting of computer vision, image correlation, pattern recognition, image classification, and image recognition.

19. The wireless device of claim 17 further comprising means for displaying the location information.

20. The wireless device of claim 17 further comprising:
means for transmitting a request for aiding information to a remote data center; and
means for receiving the aiding information;
wherein the means for processing the acquired image utilizes the aiding information.

21. The wireless device of claim 20, wherein the aiding information includes a location database.

22. A wireless device for transmitting location information comprising:
a panic button for initiating a location information process;
an image capturing device with an adjustable head for acquiring at least one image of a scene in response to activation of the panic button;
a processor for preparing the captured at least one image for transmission;
a transmitter for transmitting the prepared at least one image to a processing center configured to process the at least one image to determine the location of the wireless device.
